(19) United States
(12) Patent Application Publication
(10) Pub. No.: US 2025/0376957 A1
(43) Pub. Date: Dec. 11, 2025

(54) METHOD FOR CONTROLLING AN ENGINE COMPRESSION BRAKING MODE OF AN ENGINE ARRANGEMENT

(71) Applicant: Volvo Truck Corporation, Goteborg (SE)

(72) Inventor: Stephen Malick, Stokesdale, NC (US)

(21) Appl. No.: 19/229,498

(22) Filed: Jun. 5, 2025

(30) Foreign Application Priority Data
Jun. 11, 2024 (EP) 24181349.2

(51) Int. Cl. F02D 9/02; F01L 13/06

(52) U.S. Cl. CPC F02D 9/02; F01L 13/06

(57) ABSTRACT

A method for controlling an engine compression braking mode of an engine arrangement, wherein the method comprises acquiring, during an engine compression braking mode, with one or more sensors, operating data representative of at least one engine operating parameter in the list of: in-cylinder pressure, at least one of engine rotation speed and acceleration, and at least one of noise and vibration generated by the engine arrangement in the engine compression braking mode, and wherein, upon determination of an occurrence of an abnormal engine compression braking operation by the electronic control unit, the method comprises adjusting the degree of closing of the intake air throttle by the intake actuator according to the intake actuator setting commands. The invention also relates to an electronic control unit, a computer program, at least one of an engine arrangement and a heavy-duty vehicle embodying and implementing such method.

### PRIORITY APPLICATIONS

The present application claims priority to European Patent Application No. 24181349.2, filed on Jun. 11, 2024, and entitled “METHOD FOR CONTROLLING AN ENGINE COMPRESSION BRAKING MODE OF AN ENGINE ARRANGEMENT,” which is incorporated herein by reference in its entirety.

### TECHNICAL FIELD

The disclosure relates generally to the field of controlling an engine arrangement performing an engine compression braking operation. In particular aspects, the disclosure relates to a method for controlling an engine compression braking mode of an engine arrangement. It also relates to an electronic control unit comprising processing circuitry configured to perform the method, and to a computer program product comprising program code for performing the method. The disclosure can be applied to an engine arrangement configured to perform the method. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Automotive vehicles, such as heavy-duty trucks, are typically equipped with an engine arrangement comprising a multi-cylinder reciprocating piston internal combustion engine which mechanically drives the propulsive wheels of the vehicle. Such vehicles often rely on an engine compression braking to slow down the vehicle, in order, for example, to reduce wear of the friction brake pads and/or to prevent overheating of the friction brakes, particularly on downward slopes.

It is known to control the engine arrangement so that it performs engine compression braking by acting on the amount of gas present in the cylinders of the engine at particular moments in an engine cycle. In some examples, engine compression braking involves acting on the amount of gas present in the cylinders of the engine in at least one of two distinct engine compression braking events during a given cylinder cycle.

In one distinct engine compression braking event, the gases which are compressed by the piston in a given cylinder are allowed to exit from the cylinder when the piston arrives at or near its top dead center position in the compression stroke, in order to prevent an acceleration of the piston under effect of expansion of compressed gas during the following expansion stroke. This may be achieved by slightly opening a cylinder valve when the piston arrives at or near its top dead center position in the compression stroke, so as to allow the compressed gases out from the cylinder.

In another distinct engine compression braking event, when the piston of a given cylinder is at or near a bottom dead center before the compression stroke, exhaust gases may be allowed into the cylinder so as to slow down the piston when it moves towards its top dead center. This may be done by slightly opening at least one cylinder valve connected to an exhaust manifold, while exhaust gases are prevented to be expelled from the exhaust pipe by an exhaust gas pressure regulator, thereby maintaining in the exhaust line a certain pressure above atmospheric pressure.

In most cases, the valve (or valves) which is(are) opened for the engine brake function is(are) a main exhaust valve of the given cylinder. Such an engine compression braking mode is described in document WO-A-9009514.

Multi-cylinder reciprocating piston internal combustion engines are generally constructed in a way that the pistons of the several cylinders, which are connected to the same rotating crankshaft of the engine, have a reciprocating motion inside their respective cylinders which are offset in time one from the other by an offset time, said offset time corresponding to an offset angle of the engine which is the angular displacement of the rotating crankshaft between the timing of one piston reaching its top dead center and the timing of another piston reaching its top dead center.

In a multi-cylinder reciprocating piston internal combustion engine, the engine compression braking mode involves that the engine compression breaking events, for each cylinder, are offset one from the other by a difference in timing corresponding to the offset angle of the engine. Each cylinder thus experiences a theoretically identical cyclic operation, but with a timing offset corresponding to the offset angle of the engine. Notably, each cylinder thus theoretically experiences an identical cyclic in-cylinder pressure cycle, with the timing of in-cylinder pressure cycles of the different cylinders being offset by a difference in timing corresponding to the offset angle of the engine.

The distinct engine compression braking events rely on the activation of different components of an engine compression breaking system. At least a portion of said components, which may be called cylinder-specific components, are dedicated to only one cylinder. Therefore, in case of malfunction of a cylinder-specific component, or in case of differences in the manufacturing tolerances between cylinders-specific components of different cylinders, an engine compression breaking event for a given cylinder may have an effect different to the corresponding engine compression breaking event for another cylinders. Such effect typically results in a difference between the in-cylinder pressure cycles for the two different cylinders. It has been observed that, when the difference between the cyclic operations of at least two different cylinders of the engine exceeds a certain threshold, abnormal vibration and/or noise may be induced in the engine, especially when the engine arrangement operates in its engine compression breaking mode. Such abnormal vibration and/or a noise may reach undesirable levels, for the comfort of the vehicle drive or passengers, or for people in the surroundings of the vehicle, and may even be detrimental to the longevity of one or more components of the vehicle.

There is still a need to provide for a method for preventing or alleviating the occurrence of such abnormal levels of vibration and/or noise during an abnormal engine compression braking operation.

### SUMMARY

According to a first aspect of the disclosure, a method for controlling an engine compression braking mode of an engine arrangement comprising a multi-cylinder reciprocating piston internal combustion engine, an air intake line, an exhaust line, an intake air throttle in the intake line, and an intake actuator to adjust a degree of closing of the intake air throttle, wherein the engine arrangement is configured to operate at least in a drive mode and in an engine compression braking mode, wherein the method comprises acquiring, during an engine compression braking mode, with one or more sensors, operating data representative of at least one engine operating parameter in the list of:
in-cylinder pressure, and/or
engine rotation speed and/or acceleration, and/or
noise and/or vibration generated by the engine arrangement in the engine compression braking mode,
   wherein the method comprises processing, by an electronic control unit, said operating data to determine, based on said operating data, an occurrence of an abnormal engine compression braking operation,
   wherein, upon determination of an occurrence of an abnormal engine compression braking operation by the electronic control unit, the method comprise generating, by the electronic control unit, intake actuator setting commands for the intake actuator
   wherein the intake actuator setting commands, generated by the electronic control unit, are generated based on the operating data.
   and wherein the method includes adjusting the degree of closing of the intake air throttle by the intake actuator according to the intake actuator setting commands.

The first aspect of the disclosure may seek to prevent, alleviate, limit and/or terminate the occurrence of such abnormal levels of vibration and/or noise during an abnormal engine compression braking operation. A technical benefit may include increased reliability of the engine arrangement, especially of the engine compression braking system, and/or of the valve actuation arrangement. A further technical benefit may include a reduction on nuisance to passersby.

Optionally in some examples, including in at least one preferred example, the intake actuator setting commands, generated by the electronic control unit, is generated based on the operating data via feedback-loop control. A technical benefit may include a reliable and automatic return to a normal state of operation.

Optionally in some examples, including in at least one preferred example, the intake actuator setting commands, generated by the electronic control unit, are generated based on the operating data via proportional and integral feedback-loop control. A technical benefit may include a reliable, automatic and prompt return to a normal state of operation, based on easily tunable algorithms.

Optionally in some examples, including in at least one preferred example, the intake actuator setting commands, generated by the electronic control unit upon determination of an occurrence of an abnormal engine compression braking operation by the electronic control unit, cause an increase of the closing degree of the intake throttle. A technical benefit may include a reduction the amount of air filling the cylinders, causing the in-cylinder pressure to drop.

Optionally in some examples, including in at least one preferred example, the engine arrangement comprises a compressor in the air intake line, and wherein the air intake throttle is located upstream of the compressor in the air intake line. In such a context, there may be a lower differential pressure between both sides of the intake air throttle, which may result in the technical benefit of increasing the stability of the control method.

Optionally in some examples, including in at least one preferred example, the engine arrangement comprises an exhaust gas pressure regulator in the exhaust line, said exhaust gas pressure regulator being controlled by the electronic control unit to generate, during engine compression braking mode, an exhaust gas counter-pressure in the exhaust line upstream of the exhaust gas pressure regulator, and wherein, upon determination of an occurrence of an abnormal engine compression braking operation by the electronic control unit based on said operating data, the method prioritizes regulating a closing degree of an intake air throttle in the air intake line over a modification of the control of the exhaust gas pressure regulator. A technical benefit may include prioritizing the above mentioned stability of the control method.

Optionally in some examples, including in at least one preferred example, the engine arrangement comprises, in the exhaust line, a fixed geometry turbine, and wherein the exhaust gas pressure regulator is distinct from the fixed geometry turbine. A technical benefit may include at least partially decoupling the control of exhaust gas pressure from the operation of the fixed geometry turbine.

Optionally in some examples, including in at least one preferred example, the fixed geometry turbine mechanically drives a compressor located downstream of the air intake throttle in the air intake line. A technical benefit may include at least partially decoupling the control of exhaust gas pressure from the operation of the turbo compressor, thus at least partially decoupling the control of exhaust gas pressure from that of the pressure upstream of the cylinders, said pressure having a role in the amount of air filling the cylinders.

Optionally in some examples, including in at least one preferred example, the determination, by the electronic control unit, of an occurrence of an abnormal engine compression braking operation comprises comparing, by the electronic control unit, the operating data acquired by the one or more sensors, with acceptable operating data, i.e. stored data, stored in the electronic control unit. A technical benefit may include an easily implementable and reliable determination of abnormal engine compression braking operation.

Optionally in some examples, including in at least one preferred example, the determination, by the electronic control unit, of an occurrence of an abnormal engine compression braking operation comprises comparing, by the electronic control unit, the operating data, acquired by the one or more sensors, corresponding to distinct moments of an engine cycle. A technical benefit may include a precise determination of abnormal engine compression braking operation

Optionally in some examples, including in at least one preferred example, the determination, by the electronic control unit, of an occurrence of an abnormal engine compression braking operation comprises comparing, by the electronic control unit, an engine rotating speed variation, acquired by the one or more sensors during engine compression braking mode, to an acceptable engine rotating speed variation stored in the electronic control unit (100), or by comparing, by the electronic control unit (100), engine rotating speed variation, acquired by the one or more sensors, corresponding to distinct moments of an engine cycle. A technical benefit may include an easily implementable, reliable and precise determination of abnormal engine compression braking operation.

According to a second aspect of the disclosure, it is disclosed a control unit comprising processing circuitry configured to perform the method having one or several of the features above.

According to a third aspect of the disclosure, it is disclosed a computer program product comprising program code for performing, when executed by the processing circuitry of an electronic control unit, the method having one or several of the features above.

According to a fourth aspect of the disclosure, it is disclosed an engine arrangement comprising:
a multi-cylinder reciprocating piston internal combustion engine,
an air intake line,
an exhaust line,
an intake air throttle in the air intake line,
an intake actuator to adjust a degree of closing of the intake air throttle,
an electronic control unit,
wherein the electronic control unit is configured to perform the method having one or several of the features above.

According to a fourth aspect of the disclosure, it is disclosed a heavy-duty vehicle comprising an engine arrangement as above.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein electronic control units, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is a schematic view of an exemplary vehicle in which an engine arrangement according to the disclosure may be integrated.

FIG. 2 is a schematic view of an exemplary engine arrangement to which the method as disclosed herein may be applied.

FIG. 3 is a schematic transverse cutout of an exemplary internal combustion engine of the engine arrangement of FIG. 2.

FIG. 4 is a schematic diagram of an exemplary electronic control unit for implementing examples disclosed herein.

FIG. 5 is a flow chart of an exemplary method for controlling an engine compression braking mode of an engine arrangement.

FIG. 6 is a schematic diagram illustrating an example of operation data acquisition engine compression braking mode of an engine arrangement.

### DETAILED DESCRIPTION

The detailed description set forth below provides information and examples of the disclosed technology with sufficient detail to enable those skilled in the art to practice the disclosure.

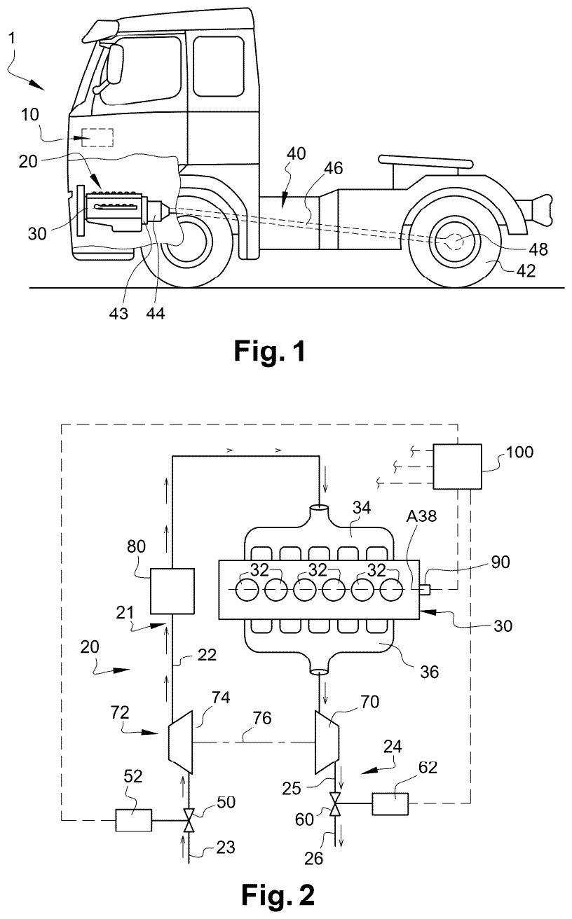

FIG. 1 is an exemplary vehicle 1 according to an example. The vehicle 1 for example in the form of a heavy-duty truck as schematically shown in FIG. 1. The vehicle 1 includes a control device 10 for controlling an engine arrangement 20 of the vehicle 1. The engine arrangement 20 includes an internal combustion engine 30, although other propulsion units may additionally be provided, such as one or more electric machines. The engine arrangement 20 mechanically drives a driveline 40 of the vehicle 1, which may include inter alia ground-engaging members in the form of drive wheels 42, a gearbox 44 mechanically driven by the internal combustion engine 30, and a driveshaft 46 mechanically connecting the gearbox 44 to the drive wheels 42 via a differential 48. The drive line 40 may further comprise for example a clutch 43, between the internal combustion engine 30 and the gearbox 44. Preferably, at least in a drive state of the drive line 40, the driveline 40 forms an uninterrupted mechanical connection between the internal combustion engine 30 and the drive wheels 42 in the sense of that a rotation of the drive wheels 42 is only possible with a corresponding rotation of the internal combustion engine 30, and vice versa. For example, the drive state of the driveline 40 may involve that the clutch 43 is in its clutched state, and that a drive gear is engaged in the gearbox 44.

The internal combustion engine 30 is a multi-cylinder reciprocating piston internal combustion engine. The internal combustion engine 30 may for example be a diesel engine, a gasoline engine, a gas engine, or a hydrogen fuel internal combustion engine.

In the example, it will be considered that the internal combustion engine 30 comprises a number N of cylinders 32, N being in the range of 2 to 16, preferably 4 to 8, N being for example 6.

FIG. 2 shows a schematic view of an exemplary cylinder 32 forming part of the internal combustion engine 30 according to FIG. 1. Each cylinder 32 has a respective cylinder axis A32. All cylinders 32 of a given internal combustion engine 30 may be identical. The cylinder 32 is provided with at least one intake valve 321 and at least one exhaust valve 322 for controlling communication between a combustion chamber 323 in the cylinder 32 and, respectively, an intake manifold 34 and an exhaust manifold 36. A piston 324 is connected via a connecting rod 325 to a rotatable crankshaft 38 and is configured to move in a reciprocating manner in said cylinder 32, along the axis A32 of the cylinder, between a top dead center position (TDC) close to the intake and exhaust valves 321, 322 (i.e. an upper end position in the orientation of FIG. 2) and a bottom dead center position (BDC) away from said valves 321, 322 (i.e. a lower end position in the orientation of FIG. 2). During operation of the internal combustion engine, the rotatable crankshaft 38 rotates around a crankshaft axis A38. The connecting rod 325 of a given cylinder 32 is journaled on a corresponding crankpin 327 of the crankshaft 38. Each crankpin 327 of the crankshaft 38 is radially offset by the same crankshaft radius with respect to the crankshaft axis A38. The crankpins 327 are preferably angularly spaced apart at a given fixed crankpin offset angle around the crankshaft axis A38. The crankpin offset angle may for example be 720°/N or 360°/N, N being the number of cylinders of the internal combustion engine.

Further, the internal combustion engine 30 is provided with a valve actuation arrangement 31 configured to control opening and closing of the inlet and exhaust valves 321, 322 of each cylinder 32. The valve actuation arrangement 31 may comprise a conventional cam and rocker arrangement, but may alternatively be a fully variable valve actuation arrangement configured to be controllable by electronic means, such as a so-called cam less valve actuation arrangement where timing and lifting of the valves 321, 322 is not activated by, nor dependent on, any camshaft but can instead be freely controlled by the fully variable valve actuation arrangement.

FIG. 2 also shows that the cylinder 32 is provided with a fuel supply system for supplying fuel, such as diesel fuel, to the cylinder 32, for example in the form of a fuel injector 326. In this example, the fuel supply system comprises as many fuel injectors 326 as the numbers of cylinders 32, with one fuel injector 326 per cylinder for injecting fuel directly into the combustion chamber 323 of the respective cylinder 32. However, the fuel supply system may comprise an indirect fuel injector for injecting fuel in the intake manifold 34, directed to several cylinders.

In the example, it will be considered that the internal combustion engine 30 is a four-stroke engine, i.e. an engine in which an engine cycle is completed in two crankshaft revolutions. The four strokes include an intake stroke, a compression stroke, a combustion/expansion stroke and an exhaust stroke. However, the internal combustion engine could alternatively also be a two-stroke engine, in which the engine cycle is completed in a single crankshaft revolution. In this case, intake and exhaust occur during the same stroke.

In a four-stroke engine, each cylinder 32 follows a cyclic operation where a cylinder cycle is completed in two crankshaft revolutions. In a two-stroke engine, each cylinder 32 follows a cyclic operation where a cylinder cycle is completed in one crankshaft revolution. Preferably, the crankshaft 38 of the internal combustion engine 30 is constructed to achieve regular offset angles between the cylinder cycles of the N cylinders. For example, in a four-stroke engine, the offset angles between the cylinder cycles of the N cylinders is 720°/N.

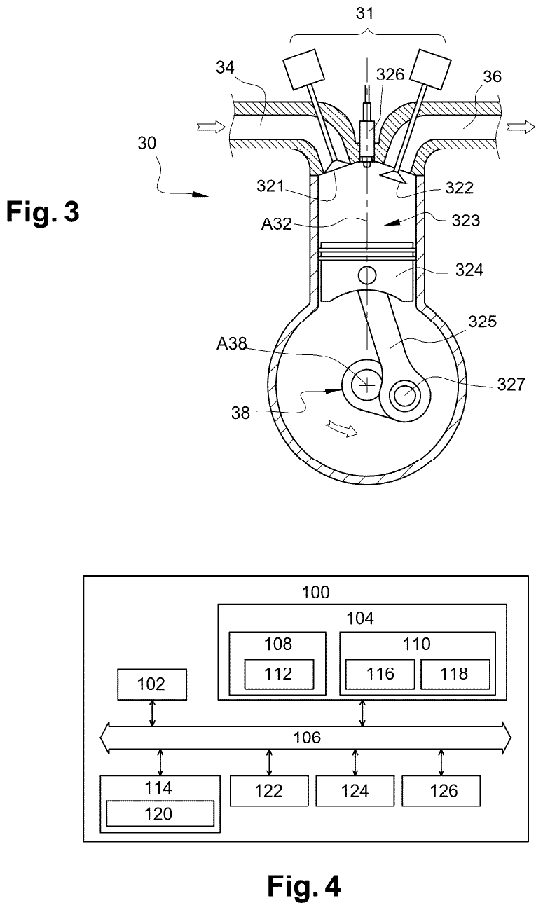

FIG. 3 shows a schematic view of an engine arrangement 20 according to FIG. 1, comprising an internal combustion engine 30. In this example the internal combustion engine 30 is provided with six identical cylinders 32 all being arranged in-line, as shown in FIG. 2. The engine arrangement 20 comprises an air intake line 21 which channels and directs intake air to an intake side of the internal combustion engine 30. The air intake line 21 may comprise a main intake duct 22 which circulates the intake air from a fresh air inlet 23 to the intake manifold 34 of the internal combustion engine 30.

The engine arrangement 20 comprises an exhaust line 24, which collects the exhaust gases coming out of the cylinders 32 and directs those exhaust gases towards the atmosphere. The exhaust line 24 may comprise a main exhaust duct 25 which circulates the exhaust gases from the exhaust manifold 36 of the internal combustion engine 30 to an exhaust outlet 26 to the atmosphere.

The engine arrangement 20 comprises an intake air throttle 50 in the air intake line 22. The intake air throttle 50 acts as a valve for varying the available flow cross-section of the air intake line 22 at the level of the intake throttle 50. The air intake throttle 50 typically comprises a movable valve member which, depending on its position, defines the degree of closing or of opening of the intake air throttle 50, which defines the available flow cross-section of the air intake line 22 at the level of the intake throttle 50. The movable member may for example be a butterfly valve, a sliding piston, a diaphragm, etc. . . . The intake air throttle 50 exhibits at least a minimally closed state, defining a minimum available flow cross-section, and a maximally closed state, defining a maximum available flow cross-section. The intake air throttle 50 preferably exhibits at least several distinct intermediate closed states between a minimally closed state and a maximally closed state, each defining an intermediate available flow cross-section. The air intake throttle 50 is preferably a proportional throttle. It may be a discrete proportional throttle exhibiting a limited number of discrete distinct intermediate closed states between the minimally closed state and the maximally closed state. Preferably, the air intake throttle 50 is a continuous proportional throttle which can be set into any intermediate closed state between a minimally closed state and the maximally closed state.

The air intake throttle 50 comprises an intake actuator 52 to adjust a degree of closing of the intake air throttle. The air intake actuator 52 may for example be an electrically powered actuator, a pneumatically powered actuator or a hydraulically powered actuator. The movable member of the air intake throttle may be a butterfly valve, a sliding piston, a diaphragm, etc. . . .

The engine arrangement comprises at least one electronic control unit 100 which may be formed by the control device 10, or may be formed by a portion of the control device 10, or may comprise of the control device 10, or may communicate electronically with the control device 10.

In some examples, the engine arrangement 20 comprises an exhaust gas pressure regulator 60 in the exhaust line 24. As well known in the art, the exhaust gas pressure regulator 60 is controlled by the electronic control unit 100 to generate, during engine compression braking mode, an exhaust gas counter-pressure in the exhaust line 25 upstream of the exhaust gas pressure regulator 60.

The exhaust gas pressure regulator 60 acts as a valve for varying the available flow cross-section of the exhaust line 24 at the level of the exhaust gas pressure regulator 60. The exhaust gas pressure regulator 60 typically comprises a movable valve member which, depending on its position, defines the degree of closing or of opening of the exhaust gas pressure regulator 60, which defines the available flow cross-section of the exhaust line 24 at the level of the exhaust gas pressure regulator 60. The movable member may for example be a butterfly valve, a sliding piston, a diaphragm, etc. . . . The exhaust gas pressure regulator 60 exhibits at least a minimally closed state and a maximally closed state. The exhaust gas pressure regulator 60 preferably exhibits at least several distinct closed states between a minimally closed state and a maximally closed state. The exhaust gas pressure regulator 60 is preferably a proportional throttle. It may be a discrete proportional throttle exhibiting a limited number of discrete distinct intermediate closed states between the minimally closed state and the maximally closed state. Preferably, the exhaust gas pressure regulator 60 is a continuous proportional throttle which can be set into any intermediate closed state between a minimally closed state and the maximally closed state. The exhaust gas pressure regulator 60 comprises an exhaust actuator 62 to adjust a degree of closing of the exhaust gas pressure regulator 60. The exhaust actuator 62 may for example be an electrically powered actuator, a pneumatically powered actuator or a hydraulically powered actuator. The movable member of the exhaust gas pressure regulator 60 thus forms an adjustable flow restricting member configured to be controlled to restrict a flow of gas through the main exhaust duct 25, so as to allow building up of a backpressure upstream of the exhaust gas pressure regulator 60 during engine compression braking.

In FIG. 3, it is shown that the engine arrangement 20 may comprise, in the exhaust line 25, a turbine 70. The turbine 70 is arranged in the exhaust line 25 between the exhaust manifold 36 of the internal combustion engine 30 and the exhaust outlet 26. In the example shown on FIG. 3, the turbine 70 is located in the exhaust line 25 upstream of the exhaust gas pressure regulator 60, more specifically between the exhaust manifold 36 of the internal combustion engine 30 and the exhaust gas pressure regulator 60. As shown in the example, the turbine 70 is preferably distinct from the exhaust gas pressure regulator 60. The turbine 70 may be a fixed geometry turbine. The turbine 70 recovers energy from the exhaust gases circulating in the exhaust line 25. In the example, the turbine 70 is part of a turbocharging arrangement 72.

In FIG. 3, it has been indicated that the engine arrangement 20 may comprise a compressor 74 in the intake line 72, for example a centrifugal compressor. In an example, the air intake throttle 50 is located upstream of the compressor 72 in the air intake line 22. In the example, the compressor 74 is part of a turbocharging arrangement, which in the example is the turbocharging arrangement 72 discussed above where the turbine is located 25 upstream of the exhaust gas pressure regulator 60 in the exhaust line 24.

In the example, the turbocharging arrangement 72 thus comprises a turbocharger compressor 74 in the intake line and a turbine 70 in the exhaust line 75, which are mechanically connected via a shaft 76. Exhaust gas leaving the cylinders 32 via the exhaust manifold 36 is channeled via the main exhaust duct 25 to the turbine 70 which drives the compressor 74. In the example, the fixed geometry turbine 70, which is distinct from the exhaust gas pressure regulator 60 in the exhaust line, mechanically drives the compressor 74 located downstream of the air intake throttle 50 in the air intake line 22.

In the example of FIG. 3, the intake line 21 comprises a heat exchanger 80 for cooling the intake air before entering into intake manifold 34. The heat exchanger 80 is located downstream of the compressor 74 the intake line 21, thus, in this example, downstream of the intake air throttle 50.

The at least one electronic control unit 100 is configured to control, at least in part, operation of the engine arrangement 20, which may include controlling, at least in part, operation of the internal combustion engine 30. This may include e.g. controlling the fuel supply system, controlling intake and exhaust valves 321, 322, etc. . . . The may also include controlling the engine arrangement 20, so as to set it in an engine compression braking mode. In line with conventional engines, the electronic control unit 100 is configured to control also various other components of the internal combustion engine 30 and to receive various input signals from sensors of various kinds such as an engine rotation speed and/or acceleration sensor 90.

FIG. 4 is a schematic diagram of an electronic control unit 100 for implementing examples disclosed herein. The electronic control unit 100 is adapted to execute instructions from a computer-readable medium to perform these and/or any of the functions or processing described herein. The electronic control unit 100 may be connected (e.g., networked) to other machines in a LAN (Local Area Network), LIN (Local Interconnect Network), automotive network communication protocol (e.g., FlexRay), an intranet, an extranet, and/or the Internet. While only a single device is illustrated, the electronic control unit 100 may include any collection of devices that individually or jointly execute a set (or multiple sets) of instructions to perform any one or more of the methodologies discussed herein. Accordingly, any reference in the disclosure and/or claims to an electronic control unit, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, electronic control unit may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The electronic control unit 100 may comprise at least one computing device or electronic device capable of including firmware, hardware, and/or executing software instructions to implement the functionality described herein. The electronic control unit 100 may include processing circuitry 102 (e.g., processing circuitry including one or more processor devices or control units), a memory 104, and a system bus 106. The electronic control unit 100 may include at least one computing device having the processing circuitry 102. The system bus 106 provides an interface for system components including, but not limited to, the memory 104 and the processing circuitry 102. The processing circuitry 102 may include any number of hardware components for conducting data or signal processing or for executing computer code stored in memory 104. The processing circuitry 102 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 102 may further include computer executable code that controls operation of the programmable device.

The system bus 106 may be any of several types of bus structures that may further interconnect to a memory bus (with or without a memory controller), a peripheral bus, and/or a local bus using any of a variety of bus architectures. The memory 104 may be one or more devices for storing data and/or computer code for completing or facilitating methods described herein. The memory 104 may include database components, object code components, script components, or other types of information structure for supporting the various activities herein. Any distributed or local memory device may be utilized with the systems and methods of this description. The memory 104 may be communicably connected to the processing circuitry 102 (e.g., via a circuit or any other wired, wireless, or network connection) and may include computer code for executing one or more processes described herein. The memory 104 may include non-volatile memory 108 (e.g., read-only memory (ROM), erasable programmable read-only memory (EPROM), electrically erasable programmable read-only memory (EEPROM), etc.), and volatile memory 110 (e.g., random-access memory (RAM)), or any other medium which can be used to carry or store desired program code in the form of machine-executable instructions or data structures and which can be accessed by a computer or other machine with processing circuitry 102. A basic input/output system (BIOS) 112 may be stored in the non-volatile memory 108 and can include the basic routines that help to transfer information between elements within the electronic control unit 100.

The electronic control unit 100 may further include or be coupled to a non-transitory computer-readable storage medium such as the storage device 114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 114 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 114 and/or in the volatile memory 110, which may include an operating system 116 and/or one or more program modules 118. All or a portion of the examples disclosed herein may be implemented as a computer program 120 stored on a transitory or non-transitory computer-usable or computer-readable storage medium (e.g., single medium or multiple media), such as the storage device 114, which includes complex programming instructions (e.g., complex computer-readable program code) to cause the processing circuitry 102 to carry out actions described herein. Thus, the computer-readable program code of the computer program 120 can comprise software instructions for implementing the functionality of the examples described herein when executed by the processing circuitry 102. In some examples, the storage device 114 may be a computer program product (e.g., readable storage medium) storing the computer program 120 thereon, where at least a portion of a computer program 120 may be loadable (e.g., into a processor) for implementing the functionality of the examples described herein when executed by the processing circuitry 102. The processing circuitry 102 may serve as a controller or control system for the electronic control unit 100 that is to implement the functionality described herein.

The electronic control unit 100 may include an input device interface 122 configured to receive input and selections to be communicated to the electronic control unit 100 when executing instructions, such as from a keyboard, mouse, touch-sensitive surface, etc. Such input devices may be connected to the processing circuitry 102 through the input device interface 122 coupled to the system bus 106 but can be connected through other interfaces, such as a parallel port, an Institute of Electrical and Electronic Engineers (IEEE) 1394 serial port, a Universal Serial Bus (USB) port, an IR interface, and the like. The electronic control unit 100 may include an output device interface 124 configured to forward output, such as to a display, a video display unit (e.g., a liquid crystal display (LCD) or a cathode ray tube (CRT)). The electronic control unit 100 may include a communications interface 126 suitable for communicating with a network as appropriate or desired.

The electronic control unit 100 may thus receive operating data and/or operating parameters from one or more sensors, including from the sensors discussed below. The electronic control unit 100 may thus process said operating data and/or operating parameters, for example to generate setting commands for one or several actuators of the engine arrangements, including to the actuators as discussed below. The electronic control unit 100 preferably comprises the processing circuitry 102 configured to configured to perform the method as described hereunder. For example, a computer program product may be provided to the electronic control unit, this computer program product comprising program code for performing, when executed by the processing circuitry 102 of the electronic control unit 100, the method as described hereunder.

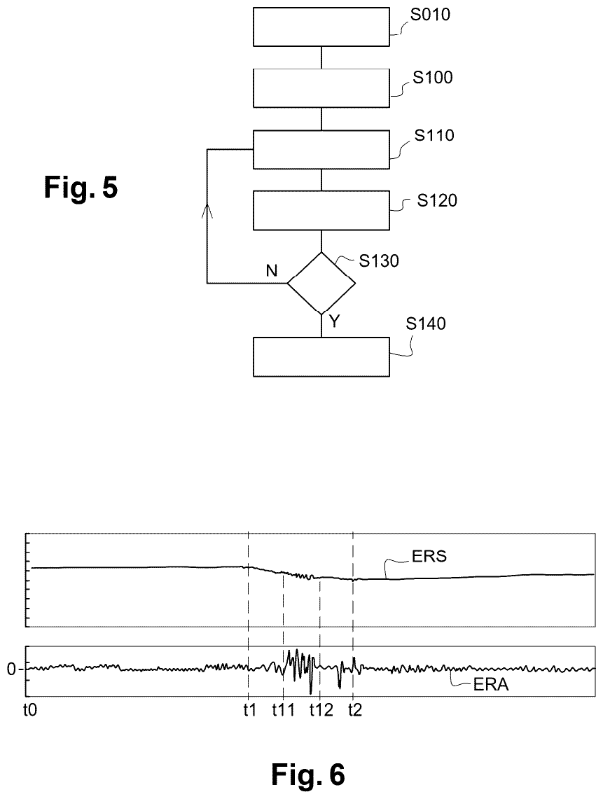

It is indeed herein disclosed a method for controlling an engine compression braking mode of an engine arrangement 20 as described above. An example of such method may be illustrated schematically by the flowchart of FIG. 5.

The engine arrangement 20 is configured to operate at least in a drive mode and in an engine compression braking mode. In the drive mode, fuel is supplied to the cylinders 32 of the internal combustion engine so that a positive torque is generated by the internal combustion engine 30 and delivered to the driveline 40 through the crankshaft 38. Typically, the drive mode is performed when the driver of the vehicle depresses an accelerator pedal. For example, the electronic control unit 100 receives a signal from an accelerator pedal sensor indicative of the amount of torque which is required from the engine arrangement 20, and the electronic control unit 100 generates corresponding setting commands which are used to control the engine arrangement 20. In FIG. 5, step S010 illustrates the engine arrangement 20 being in a drive mode.

The engine compression braking mode is usually performed when the driver provides a corresponding input through a suitable input device of the vehicle, and is usually performed only when the driver stops depressing the accelerator pedal. For example, at step S100, the electronic control unit 100 receives a no-acceleration signal from the accelerator pedal sensor and receives an engine compression braking instruction from a corresponding input device. In such a case, at step S110, the electronic control unit 100 generates corresponding engine compression braking setting commands which are used to control the engine arrangement 20.

In the engine compression braking mode, fuel delivery to the internal combustion engine 30 is interrupted by the electronic control unit 100 generating a corresponding setting command which is delivered to the fuel supply system.

Conventionally, in the engine compression braking mode, the method involves acting on the amount of gas present in the cylinders of the engine in at least one engine compression braking event. This may be achieved by altering the opening cycle of at least one cylinder valve, which may be one or more of the intake and exhaust valves 321, 3222. To that effect, the electronic control unit 100 generates, during step S110, corresponding valve opening altering setting commands which are delivered to the valve actuation arrangement 31.

For example, in one distinct engine compression braking event for a given cylinder 32, the gases which are compressed by the piston 324 of that given cylinder are allowed to exit from the cylinder 32 when the piston 324 arrives at or near its top dead center position TDC in the compression stroke, in order to prevent an acceleration of the piston under effect of expansion of compressed gas during the following expansion stroke. This may be achieved by slightly opening a cylinder valve when the piston arrives at or near its top dead center position in the compression stroke, so as to allow the compressed gases out from the cylinder.

In another exemplary distinct engine compression braking event, when the piston 324 of a given cylinder is at or near a bottom dead center before or at the beginning of the compression stroke, exhaust gases, contained in the exhaust manifold 36, may be allowed back into the given cylinder 32 so as to slow down the piston of that cylinder when it moves towards its top dead center. This may be done by slightly opening at least one cylinder valve connected to the exhaust manifold 36.

In most cases, the valve (or valves) which is(are) opened for the engine compression braking event is(are) a main exhaust valve 322 of the given cylinder 322. Such an engine compression braking mode, and examples of corresponding valve actuation arrangements 31, are described in documents WO-A-9009514, WO9108381A1, WO03031778A1, WO2013014490A1 or WO2014049388A1, which hereby incorporated by reference.

Moreover, the engine compression braking mode may comprise controlling the exhaust gas pressure regulator 60 to generate, during engine compression braking mode, an exhaust gas counter-pressure in the exhaust line 24 upstream of the exhaust gas pressure regulator 60. This may be achieved by the electronic control unit 100 generating, during step S110, a corresponding exhaust gas pressure regulator setting command which is delivered to the exhaust actuator 62 to adjust a degree of closing of the exhaust gas pressure regulator 60.

According to one aspect, the method for controlling an engine compression braking mode of an engine arrangement 20 comprises acquiring, during an engine compression braking mode, with one or more sensors, operating data representative of at least one engine operating parameter in the list of:
in-cylinder pressure, and/or
engine rotation speed and/or acceleration and/or
noise and/or vibration generated by the engine arrangement in the engine compression braking mode.

This operating data acquisition is performed at step S120 of FIG. 5, and is preferably performed through the entire extent of operation of the engine arrangement 20 in the engine compression braking mode, either continuously or at regular intervals.

The in-cylinder pressure is the pressure in the combustion chamber 33 of a given cylinder 32. In-cylinder pressure evolves over the span of an engine cycle, be it a two-stroke or a four stroke cycle.

In some examples, an operating parameter representative of in-cylinder pressure may be acquired for each cylinder 32 of the internal combustion engine 30. An operating parameter representative of in-cylinder pressure may for example be, or may be based on, one or more of the following:
an instant value of the in-cylinder pressure at a given predefined time in the engine cycle for that cylinder, for example at a given predefined time in the compression stroke for that cylinder 32;
a mean value of the in-cylinder pressure over a given predefined time range in the engine cycle for that cylinder, for example at a given predefined time range in the compression stroke for that cylinder 32;
a peak value of the in-cylinder pressure within a given predefined time range in the engine cycle for that cylinder, for example within a given predefined time range in the compression stroke for that cylinder 32.

An in-cylinder pressure may for example be acquired by a pressure sensor inside the combustion chamber 33 or connected to the combustion chamber 33.

Engine rotation speed and acceleration are respectively the rotation speed and the rotation acceleration of the crankshaft 38 of the internal combustion engine 30 around its axis A38. Engine rotation speed and/or acceleration may be acquired by conventional sensors 90, for example one or more optical or magnetic sensor. For example, such one or more sensors 90 may detect features on a flywheel of the internal combustion engine 30. In particular one or more sensors 90 may detect gearing teeth of a crown gearing of a flywheel of the internal combustion engine 30. Preferably, values of engine rotation speed and/or acceleration are acquired at a crankshaft angular interval which is equal or less than 360°/N, N being the number of cylinders, so as to be able to detect a variation in speed/acceleration caused by a given cylinder. Most preferably values of engine rotation speed and/or acceleration are acquired at a crankshaft angular interval which is equal or less than 360°/(k×N), N being the number of cylinders and k being a positive integer, with k preferably comprised in the range of 2 to 10.

Noise and/or vibration generated by the engine arrangement in the engine compression braking mode maybe acquired by a suitable noise and/or vibration sensors, preferably located on the internal combustion engine, or in close proximity of the internal combustion engine.

FIG. 6 is an example of operating data which may be acquired during step 120. In this example, the operating data comprises at least two engine operating parameters including engine rotation speed (ERS) and engine rotation acceleration (ERA). In the diagram of FIG. 7, it is shown that engine rotation speed ERS and engine rotation acceleration ERA may be acquired also during the driving mode of the engine arrangement 20. In FIG. 6, it is shown that during a first time interval until a time point t1, the engine arrangement 20 is operated in a driving mode, with a substantially constant engine rotation speed. During a second time interval, between time point t1 and a subsequent time point t2, the engine arrangement is operated in an engine compression breaking mode. After the time point t2, the engine arrangement 20 is switched back to the driving mode.

The method comprises processing, by the electronic control unit 100, said operating data to determine, based on said operating data, an occurrence of an abnormal engine compression braking operation. Preferably an abnormal engine compression braking operation as determined by the method is an engine compression braking operation where at least one cylinder 32 does not behave similarly to one or several other cylinders 32 in the amount of contribution to the engine compression braking torque generated. In most cases, such different behavior is the result of a difference in the in-cylinder pressure for that at least one cylinder with respect to the other cylinders of the internal combustion engine 30, for example a difference in a mean value and/or in a peak value of the in-cylinder pressure within a given predefined time range in the engine cycle for that cylinder, for example within a given predefined time range in the compression stroke for that cylinder 32.

Such difference in behavior may for example originate in manufacturing dispersions, or originate in wear dispersions between corresponding components of the respective cylinders 32, including but not limited to components of the valve actuation arrangements 31, of the valves 321, 322, of valve seats, and/or of piston sealing rings, etc. . . .

The determination, by the electronic control unit 100, an occurrence of an abnormal engine compression braking operation may for example comprises comparing, by the electronic control unit 100, the operating data acquired by the one or more sensors, with acceptable operating data stored in the electronic control unit 100. Acceptable operating data stored in the electronic control unit 100 are predetermined data stored in the electronic control unit. Those predetermined data are deemed to represent an acceptable operation of the engine arrangement, i.e. at which noise and vibration are at acceptable levels. Therefore, what is acceptable operating data is predefined and stored in the electronic control unit 100. The acceptable operating data stored in the electronic control unit 100 may for example be, or may for example comprise, one or several threshold values to which the operating data acquired by the one or more sensors is to be compared. The electronic control unit 100 may for example determine that an abnormal engine compression braking operation occurs if one or several threshold values are crossed. The acceptable operating data may be dependent or independent of operating parameters of the engine arrangement 20. For example acceptable operating data may comprise data which is dependent on one or several operating parameters of the engine arrangement 20 (e.g. dependent on current engine speed, on a currently engaged gear ratio of a gearbox, on an engine fluid temperature, etc. . . . ). In such a case, acceptable operating data may comprise one or several predetermined formulas stored in the electronic control unit 100, the one or several predetermined formulas having one or several operating parameters of the engine arrangement 20 as variables.

In addition, or alternatively, the determination, by the electronic control unit 100, of an occurrence of an abnormal engine compression braking operation may for example comprise comparing, by the electronic control unit 100, the operating data, acquired by the one or more sensors, corresponding to distinct moments of an engine cycle. For example, the distinct moments of an engine cycle may correspond to corresponding moments of the different cylinder cycles. For example, the distinct moments of an engine cycle, for which the operating data acquired by the one or more sensors is compared, may correspond to the compression stroke of each cylinder 32. The electronic control unit 100 may for example determine that an abnormal engine compression braking operation occurs if the operating data, acquired by the one or more sensors, corresponding to distinct moments of an engine cycle, differ by a value which exceeds a threshold value which may be predetermined or which may be calculated on the bases of operating parameters of the engine arrangement.

As an example, the determination, by the electronic control unit, of an occurrence of an abnormal engine compression braking operation may comprise comparing, by the electronic control unit 100, an engine rotating speed variation of the engine, acquired by the one or more sensors during engine compression braking mode, to an acceptable engine rotating speed variation, i.e. a stored predefined rotating speed variation where noise and vibration are considered to be at acceptable levels, stored in the electronic control unit.

In one example, the electronic control unit 100 can receive the engine rotating speed from a conventional engine rotating speed sensor to detect if there are variations in engine rotating speed that are abnormal. As an example, an abnormal change in engine rotating speed can be predefined as a variation which is faster than a variation that can occur from a throttle or torque change request from the driver during a timeframe having a duration which may be chosen in the range from 20 ms to 100 ms. If the variation is determined as abnormal by the electronic control unit 100, adjusting the degree of closing of the intake air throttle 50 is performed as disclosed herein, for example by increasing the degree of closing of the intake air throttle 50 to reduce the amount of air entering the cylinder during engine compression braking. Once the engine rotating speed has settled to a slower engine rotating speed, then it can be determined that the vibration event is over and electronic control unit 100 can allow normal engine compression braking operation. It may be possible to implement a delay before returning to normal engine compression braking operation, for example allowing to return to normal engine compression braking operation after it has been determined that variations in engine rotating speed are not abnormal for at least a certain threshold of time.

Turning back to the example of FIG. 6, when looking at the operating parameters acquired during the engine compression braking mode, between time point t1 and subsequent time point t2, it can be noticed that the engine rotation speed ERS decreases. However, within that time interval, it can be noticed the particular time interval, ranging from time point t11 to time point t12, where the engine rotation speed exhibits, while following a global decreasing tendency, an oscillatory variation. Similarly, during the same particular time interval, ranging from time point t11 to time point t12, the engine rotation acceleration exhibits an oscillatory variation alternating between positive values and negative values. These oscillatory variations of the engine rotation speed ERS and of the engine rotation acceleration ERA correspond to an occurrence of an abnormal engine compression braking operation, which would typically result in increased noise and/or vibration generated in the engine arrangement 20. Typically, the engine rotation acceleration ERA having an oscillatory variation alternating between positive values and negative values tend to result in increased 3^{rd} order vibrations, that can be felt as noise and/or vibrations for an operator, and can result in accelerated wear on internal components of the engine. When the engine rotation acceleration ERA is found to have a larger oscillatory variation alternating between positive values and negative values, it may be found that larger 3^{rd} order vibrations are generated. For example, when the engine rotation acceleration ERA has an oscillatory variation alternating between positive values and negative values, where the variation exceeds an acceptable variation value, i.e. a predetermined variation value, stored in the electronic control unit 100, it may be determined that an abnormal engine compression braking operation is occurring.

The determination of an occurrence of any abnormal engine compression braking operation is performed at step S130 of FIG. 5, and is preferably performed through the entire extent of operation of the engine arrangement 20 in the engine compression braking mode, either continuously or at regular intervals. As long as no abnormal engine compression braking operation is determined (N) to occur, the method may continue the engine compression braking mode as performed at step S110 of FIG. 5.

On the other hand, upon determination of an occurrence of an abnormal engine compression braking operation (Y) by the electronic control unit 100, the method comprise generating, at step S140 of FIG. 5, by the electronic control unit 100, intake actuator setting commands for the intake actuator 52. Those intake actuator setting commands, generated by the electronic control unit 100, are generated based on the operating data. These intake actuator setting commands, which are generated in the method upon determination of an occurrence of an abnormal engine compression braking operation (Y), include adjusting the degree of closing of the intake air throttle 50 by the intake actuator 50 according to the intake actuator setting commands.

In most cases, the intake actuator setting commands, generated by the electronic control unit upon determination of an occurrence of an abnormal engine compression braking operation by the electronic control unit 100, cause an increase of the closing degree of the intake throttle compared to a similar situation of the vehicle where no abnormal engine compression braking operation would have been found. Such action tends to reduce the amount of air filling the cylinders, causing the in-cylinder pressure to drop. This will allow the intake and exhaust valves 321, 322 to operate effectively.

An effect of the increasing of the closing degree of the intake throttle, compared to a similar situation of the vehicle where no abnormal engine compression braking operation would have been found, is that a more limited amount of intake air will be entered into all of the cylinders 32 of the internal combustion engine during their respective intake stroke. As a result, the in-cylinder pressure during the immediately subsequent compression stroke will be lower compared to a similar situation of the vehicle where no abnormal engine compression braking operation would have been found.

It has been determined that such a reduction of the in-cylinder pressure, during engine compression braking operation, reduces the tendency of one cylinder behaving differently from the other cylinders. This leads to a reduction of the noise and/or vibrations generated due to an abnormal engine compression braking operation.

It has been determined that such a reduction, obtained via an increased closing degree of the air intake throttle 50, can be sufficient to reduce the noise and vibration to acceptable levels in most circumstances. In most operating situations of the engine arrangement, an increased closing degree of the air intake throttle 50 can be sufficient to reduce the noise and vibration to acceptable levels, without altering the other setting commands of the engine arrangement compared to a similar situation of the vehicle where no abnormal engine compression braking operation would have been found. For example, in those cases where the exhaust pressure regulator 60 has been set to a position to increase the exhaust gas pressure in the exhaust line upstream of the exhaust pressure regulator 60, it has been found that an increased closing degree of the air intake throttle 50 can be sufficient to reduce the noise and vibration to acceptable levels, without altering the a degree of closing of the exhaust gas pressure regulator 60 compared to a similar situation of the vehicle where no abnormal engine compression braking operation would have been found.

However, in certain operating situations, it may be chosen or it may be even desirable or necessary to alter other setting commands of the engine arrangement 20, compared to a similar situation of the vehicle where no abnormal engine compression braking operation would have been found, in addition to setting an increased closing degree of the air intake throttle 50. In such a case, it may nevertheless be provided that, upon determination of an occurrence of an abnormal engine compression braking operation (Y) by the electronic control unit 100 based on said operating data, the method prioritizes regulating a closing degree of an intake air throttle 50 in the air intake line over a modification of the exhaust gas pressure generated by the exhaust gas pressure regulator. For example, closing degree of an intake air throttle 50 in the air intake line, is performed at least to certain extent before any modification of the exhaust gas pressure generated by the exhaust gas pressure regulator, and/or a closing degree of an intake air throttle 50 in the air intake line is performed to a greater extent that the extent of modification of the exhaust gas pressure generated by the exhaust gas pressure regulator.

In some examples, the intake actuator setting commands, generated by the electronic control unit 100, are generated based on the operating data via feedback-loop control.

In some examples the intake actuator setting commands, generated by the electronic control unit, are generated based on the operating data via proportional and integral feedback-loop control.

It has been determined that adjusting the degree of closing of the intake air throttle by the intake actuator according to the intake actuator setting commands is an effective way to reduce the noise and/or vibrations generated due to an abnormal engine compression braking operation. Such mode of action is more precise in that a desired reduction of noise and/or vibrations can be achieved with a lesser reduction of the engine compression braking efficacy. One aspect is that the differential pressure between both sides of the intake air throttle 50 in the intake line 21 is not very high because the pressure upstream of the intake air throttle 50 in the intake line 21 is not very high. Thereby, any initial error or approximation in the adjustment the degree of closing of the intake air throttle causes a lower effect in the engine compression braking efficacy, than if adjustment would be performed through other systems where a higher pressure differential exists. The relatively low pressure upstream of the intake air throttle 50 in the intake line 21 is favorable for the stability of the control method, including when the intake actuator setting commands, generated by the electronic control unit 100, are generated based on the operating data via feedback-loop control. Thus a proper and precise control can be achieved, without having to aggressively reduce the efficacy of the engine compression braking operation. The relatively low pressure upstream of the intake air throttle 50 in the intake line 21 is of course lower if, as in the example of FIG. 3, the air intake throttle 50 is located upstream of the compressor 74 in the air intake line 21, preferably upstream of any compressor 74 in the air intake line 21, both configurations being thus favorable.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The disclosure further comprises the disclosure of the following examples of a method for controlling an engine compression braking mode of an engine arrangement (20).

Example 1: a method for controlling an engine compression braking mode of an engine arrangement (20) comprising a multi-cylinder reciprocating piston internal combustion engine (30), an air intake line (21), an exhaust line (24), an intake air throttle (50) in the intake line (21), and an intake actuator (52) to adjust a degree of closing of the intake air throttle (50),
wherein the engine arrangement (20) is configured to operate at least in a drive mode and in an engine compression braking mode,
   wherein the method comprises acquiring, during an engine compression braking mode, with one or more sensors (90), operating data representative of at least one engine operating parameter (ERS; ERA) in the list of:
in-cylinder pressure, and/or
engine rotation speed (ERS) and/or acceleration (ERA), and/or
noise and/or vibration generated by the engine arrangement (20) in the engine compression braking mode,
   wherein the method comprises processing, by an electronic control unit (100), said operating data to determine, based on said operating data, an occurrence of an abnormal engine compression braking operation,
   wherein, upon determination of an occurrence of an abnormal engine compression braking operation by the electronic control unit (100), the method comprise generating, by the electronic control unit (100), intake actuator setting commands for the intake actuator (52)
   wherein the intake actuator setting commands, generated by the electronic control unit (100), are generated based on the operating data.
   and wherein the method includes adjusting the degree of closing of the intake air throttle (50) by the intake actuator (52) according to the intake actuator setting commands.

Example 2. The method of Example 1, wherein the intake actuator setting commands, generated by the electronic control unit (100), are generated based on the operating data via feedback-loop control.

Example 3. The method of Example 1, wherein the intake actuator setting commands, generated by the electronic control unit (100), are generated based on the operating data via proportional and integral feedback-loop control.

Example 4: The method according to any one of the preceding Examples, wherein the intake actuator setting commands, generated by the electronic control unit (100) upon determination of an occurrence of an abnormal engine compression braking operation by the electronic control unit (100), cause an increase of the closing degree of the intake throttle (50).

Example 5: The method according to any one of the preceding Examples, wherein the engine arrangement (20) comprises a compressor (74) in the air intake line (21), and wherein the air intake throttle (50) is located upstream of the compressor (74) in the air intake line (21).

Example 6: The method according to any one of the preceding Examples, wherein the engine arrangement (20) comprises an exhaust gas pressure regulator (60) in the exhaust line (24), said exhaust gas pressure regulator (60) being controlled by the electronic control unit (100) to generate, during engine compression braking mode, an exhaust gas counter-pressure in the exhaust line (24) upstream of the exhaust gas pressure regulator (60), and wherein, upon determination of an occurrence of an abnormal engine compression braking operation by the electronic control unit (100) based on said operating data, the method prioritizes regulating a closing degree of an intake air throttle (50) in the air intake line (21) over a modification of the control of the exhaust gas pressure regulator (60).

Example 7: The method of Example 6 where the engine arrangement (60) comprises, in the exhaust line (21), a fixed geometry turbine (70), and wherein the exhaust gas pressure regulator (60) is distinct from the fixed geometry turbine (60).

Example 8: The method of Example 7 where the fixed geometry turbine (70) mechanically drives a compressor (74) located downstream of the air intake throttle (50) in the air intake line (21).

Example 9. The method according to any one of the preceding Examples, wherein the determination, by the electronic control unit (100), of an occurrence of an abnormal engine compression braking operation comprises comparing, by the electronic control unit (100), the operating data acquired by the one or more sensors (90), with acceptable operating data stored in the electronic control unit (100).

Example 10: The method according to any one of the preceding Examples, wherein the determination, by the electronic control unit (100), of an occurrence of an abnormal engine compression braking operation comprises comparing, by the electronic control unit (100), the operating data, acquired by the one or more sensors (90), corresponding to distinct moments of an engine cycle.

Example 11. The method of any one of the preceding Examples, wherein the determination, by the electronic control unit (100), of an occurrence of an abnormal engine compression braking operation comprises comparing, by the electronic control unit (100), an engine rotating speed variation, acquired by the one or more sensors during engine compression braking mode, to an acceptable engine rotating speed variation stored in the electronic control unit (100), or by comparing, by the electronic control unit (100), engine rotating speed variation, acquired by the one or more sensors (90), corresponding to distinct moments of an engine cycle.

As an example 12, the disclosure further comprises the disclosure of a control unit (100) comprising processing circuitry (102) configured to perform the method according to any of Examples 1-11.

As an example 13, the disclosure further comprises the disclosure of a computer program product comprising program code for performing, when executed by the processing circuitry (102) of an electronic control unit (100), the method of any of Examples 1-11.

As an example 14, the disclosure further comprises the disclosure of an engine arrangement (20) comprising:
a multi-cylinder reciprocating piston internal combustion engine (30),
an air intake line (21),
an exhaust line (24),
an intake air throttle (50) in the air intake line (21),
an intake actuator (52) to adjust a degree of closing of the intake air throttle (50),
an electronic control unit (100),
wherein the electronic control unit (100) is configured to perform the method according to any of Examples 1-11.

As an example 15, the disclosure further comprises the disclosure of a heavy-duty vehicle (1) comprising an engine arrangement (20) according to Example 14.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A method for controlling an engine compression braking mode of an engine arrangement comprising a multi-cylinder reciprocating piston internal combustion engine, an air intake line, an exhaust line, an intake air throttle in the intake line, and an intake actuator to adjust a degree of closing of the intake air throttle;
wherein the engine arrangement is configured to operate at least in a drive mode and in an engine compression braking mode;
wherein the method comprises acquiring, during an engine compression braking mode, with one or more sensors, operating data representative of at least one engine operating parameter in the list of:
in-cylinder pressure;
at least one of engine rotation speed and acceleration; and
at least one of noise and vibration generated by the engine arrangement in the engine compression braking mode;
wherein the method comprises processing, by an electronic control unit, the operating data to determine, based on the operating data, an occurrence of an abnormal engine compression braking operation;
wherein, upon determination of an occurrence of an abnormal engine compression braking operation by the electronic control unit, the method comprises generating, by the electronic control unit, intake actuator setting commands for the intake actuator;
wherein the intake actuator setting commands, generated by the electronic control unit, are generated based on the operating data; and
wherein the method includes adjusting the degree of closing of the intake air throttle by the intake actuator according to the intake actuator setting commands.

2. The method of claim 1, wherein the intake actuator setting commands, generated by the electronic control unit, are generated based on the operating data via feedback-loop control.

3. The method of claim 1, wherein the intake actuator setting commands, generated by the electronic control unit, are generated based on the operating data via proportional and integral feedback-loop control.

4. The method of claim 1, wherein the intake actuator setting commands, generated by the electronic control unit upon determination of an occurrence of an abnormal engine compression braking operation by the electronic control unit, cause an increase of the closing degree of the intake throttle.

5. The method of claim 1, wherein the engine arrangement comprises a compressor in the air intake line, and wherein the air intake throttle is located upstream of the compressor in the air intake line.

6. The method of claim 1, wherein the engine arrangement comprises an exhaust gas pressure regulator in the exhaust line, the exhaust gas pressure regulator being controlled by the electronic control unit to generate, during engine compression braking mode, an exhaust gas counter-pressure in the exhaust line upstream of the exhaust gas pressure regulator, and wherein, upon determination of an occurrence of an abnormal engine compression braking operation by the electronic control unit based on the operating data, the method prioritizes regulating a closing degree of an intake air throttle in the air intake line over a modification of the control of the exhaust gas pressure regulator.

7. The method of claim 6, where the engine arrangement comprises, in the exhaust line, a fixed geometry turbine, and wherein the exhaust gas pressure regulator is distinct from the fixed geometry turbine.

8. The method of claim 7, where the fixed geometry turbine mechanically drives a compressor located downstream of the air intake throttle in the air intake line.

9. The method of claim 1, wherein the determination, by the electronic control unit, of an occurrence of an abnormal engine compression braking operation comprises comparing, by the electronic control unit, the operating data acquired by the one or more sensors, with data stored in the electronic control unit.

10. The method of claim 1, wherein the determination, by the electronic control unit, of an occurrence of an abnormal engine compression braking operation comprises comparing, by the electronic control unit, the operating data, acquired by the one or more sensors, corresponding to distinct moments of an engine cycle.

11. The method of claim 1, wherein the determination, by the electronic control unit, of an occurrence of an abnormal engine compression braking operation comprises comparing, by the electronic control unit, an engine rotating speed variation, acquired by the one or more sensors during engine compression braking mode, to an engine rotating speed variation stored in the electronic control unit, or by comparing, by the electronic control unit, engine rotating speed variation, acquired by the one or more sensors, corresponding to distinct moments of an engine cycle.

12. An electronic control unit comprising processing circuitry configured to perform the method of claim 1.

13. A computer program product comprising program code for performing, when executed by the processing circuitry of an electronic control unit, the method of claim 1.

14. An engine arrangement comprising:
a multi-cylinder reciprocating piston internal combustion engine;
an air intake line;
an exhaust line;
an intake air throttle in the air intake line;
an intake actuator to adjust a degree of closing of the intake air throttle; and
an electronic control unit;
wherein the electronic control unit is configured to perform the method of claim 1.

15. A heavy-duty vehicle comprising the engine arrangement of claim 14.
